(19) United States
(12) Patent Application Publication
(10) Pub. No.: US 2026/0153164 A1
(43) Pub. Date: Jun. 4, 2026

(54) GATE VALVE WITH SPEED CONTROLLER USING CDA

(71) Applicant: ASM IP Holding B.V., Almere (NL)

(72) Inventor: Koei Aida, Tokyo (JP)

(21) Appl. No.: 19/401,819

(22) Filed: Nov. 26, 2025

Related U.S. Application Data
(60) Provisional application No. 63/726,433, filed on Nov. 29, 2024.

(51) Int. Cl. F16K 31/163; F16K 3/02; F16K 3/18; F16K 31/524

(52) U.S. Cl. CPC F16K 31/163; F16K 3/0254; F16K 3/184; F16K 31/52475

(57) ABSTRACT

Gate valve with open/close speed control capability is presented. To control open/close speed, the present disclosure presents a housing; an air cylinder configured to move a first shaft vertically up to a first position, the first shaft being connected to the air cylinder; a cam unit including a cam attached to the first shaft at one end; a second shaft connected at opposite end of the cam and configured to move along with the cam to a certain height; a first bellows disposed around the second shaft; a seal plate disposed at an end of the second shaft and configured to close a passage to/from a chamber; a seal ring disposed around the seal plate and configured to seal up the passage when the seal plate closes the passage; and a CDA unit configured to control an open/close speed of the gate valve.

### CROSS-REFERENCE TO RELATED APPLICATIONS

This application claims priority to U.S. Provisional Patent Application Ser. No. 63/726,433 filed Nov. 29, 2024 titled GATE VALVE WITH SPEED CONTROLLER USING CDA, the disclosure of which is hereby incorporated by reference in its entirety.

### FIELD OF INVENTION

The present disclosure relates generally to a gate valve used in semiconductor manufacturing, more particularly to a gate valve using a compressed dry air (CDA) to control a valve open/close speed.

### BACKGROUND OF THE DISCLOSURE

Conventionally, a gate valve may be move by an air cylinder and a cam and a seal plate moves on vertical direction and horizontal direction to open and close the valve.

In the currently used gate valves which use CDA, on CDA line may be connected in the air cylinder and because of this it may be impossible to control the speed in vertical direction and horizontal direction independently of the seal plate.

The loss of control means that if the CDA pressure and/or CDA flow speed increases, the speed the motion of vertical and horizontal directional speed of the seal place increases too and if the CDA pressure and/or CDA flow speed decreases, motion speed of both vertical and horizontal direction decreases.

Generally, we want to minimize total gate valve open/close speed. In this case we increase vertical motion speed by increasing CDA pressure and/or CDA flow speed. But unfortunately impact that the seal plate contacts to chamber also increases and this causes seal plate (O-ring) damage and particle. Independent speed control is required to resolve this issue. (See FIG. 2).

Whenever pressure reading in the pressure switch increased the cutoff limit, it signals the relay to turn off thereby actuating the interlock with this cutoff signal. Sometimes due to over current the terminals of the relay melts and provides a continuity between terminals even if the relay turns off the signal is still on thereby unaffecting the interlocking system, which can be a safety risk.

Therefore, the present disclosure provides a new pressure switch with safety features to protect the relay terminals from melting.

### SUMMARY OF THE DISCLOSURE

This summary is provided to introduce a selection of concepts in a simplified form. These concepts are described in further detail in the detailed description of example embodiments of the disclosure below. This summary is not intended to identify key features or essential features of the claimed subject matter, nor is it intended to be used to limit the scope of the claimed subject matter.

In accordance with one embodiment there may be provided, a gate valve with speed control capability, the gate valve comprising a housing; an air cylinder configured to move a first shaft vertically up to a first position, the first shaft being connected to the air cylinder; a cam unit including a cam attached to the first shaft at one end; a second shaft connected at opposite end of the cam and configured to move along with the cam to a certain height; a first bellows disposed around the second shaft; a seal plate disposed at an end of the second shaft and configured to close a passage to/from a chamber; a seal ring disposed around the seal plate and configured to seal up the passage when the seal plate closes the passage; and a CDA unit configured to control an open/close speed of the gate valve, wherein the CDA unit comprises: a casing; a piston configured to move vertically by air flow; a first air passage and a second air passage for controlling an amount of air flow; a separator configured to separate the first air passage and the second air passage, wherein the separator is equipped with a hole; and a first needle valve disposed in the middle of the first passage and configured to control the flow of an air in the first passage.

In an aspect, the CDA unit further comprising: a second needle valve disposed in the middle of the second air passage and configured to control a flow of an air in the second air passage.

In an aspect, the piston configured to block the second air passage when the piston moves at highest point and the air only flows through the first air passage.

In an aspect, the first needle valve and the second needle valve configured to independently control the air flow of the first air passage and the second air passage respectively.

In an aspect, the gate valve further comprises: a second bellows configured to dampen shocks caused by movement of the cam; a slider mounted around a second shaft; and a guide rail mounted on an inner wall of the housing, the guide rail being configured to guide the slider and restrict vertical movement.

In an aspect, area of the second air passage is bigger than area of the first air passage.

### BRIEF DESCRIPTION OF THE DRAWING FIGURES

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

FIG. 1 (a) illustrates a sideview of a gate valve when open according to an embodiment of the present disclosure; (b) illustrates a sideview of a gate valve when close according to an embodiment of the present disclosure.

FIG. 2 illustrates an overview of a gate valve according to an embodiment of the present disclosure.

FIG. 3 (a) illustrates an inside view of the CDA unit when both air passages are open according to an embodiment of the present disclosure; (b) illustrates an inside view of the CDA unit when second air passage is closed according to an embodiment of the present disclosure.

### DETAILED DESCRIPTION OF EXEMPLARY EMBODIMENTS

Although certain embodiments and examples are disclosed below, it will be understood by those in the art that the invention extends beyond the specifically disclosed embodiments and/or uses of the invention and obvious modifications and equivalents thereof. Thus, it is intended that the scope of the invention disclosed should not be limited by the particular disclosed embodiments described below.

As used herein, the term “substrate” may refer to any underlying material or materials, including any underlying material or materials that may be modified, or upon which, a device, a circuit, or a film may be formed. The “substrate” may be continuous or non-continuous; rigid or flexible; solid or porous; and combinations thereof. The substrate may be in any form, such as a powder, a plate, or a workpiece. Substrates in the form of a plate may include wafers in various shapes and sizes. Substrates may be made from semiconductor materials, including, for example, silicon, silicon germanium, silicon oxide, gallium arsenide, gallium nitride and silicon carbide.

As examples, a substrate in the form of a powder may have applications for pharmaceutical manufacturing. A porous substrate may comprise polymers. Examples of workpieces may include medical devices (for example, stents and syringes), jewelry, tooling devices, components for battery manufacturing (for example, anodes, cathodes, or separators) or components of photovoltaic cells, etc.

A continuous substrate may extend beyond the bounds of a process chamber where a deposition process occurs. In some processes, the continuous substrate may move through the process chamber such that the process continues until the end of the substrate is reached. A continuous substrate may be supplied from a continuous substrate feeding system to allow for manufacture and output of the continuous substrate in any appropriate form.

Non-limiting examples of a continuous substrate may include a sheet, a non-woven film, a roll, a foil, a web, a flexible material, a bundle of continuous filaments or fibers (for example, ceramic fibers or polymer fibers). Continuous substrates may also comprise carriers or sheets upon which non-continuous substrates are mounted.

The illustrations presented herein are not meant to be actual views of any particular material, structure, or device, but are merely idealized representations that are used to describe embodiments of the disclosure.

The particular implementations shown and described are illustrative of the invention and its best mode and are not intended to otherwise limit the scope of the aspects and implementations in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationship or physical connections may be present in the practical system, and/or may be absent in some embodiments.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. Thus, the various acts illustrated may be performed in the sequence illustrated, in other sequences, or omitted in some cases.

The subject matter of the present disclosure includes all novel and nonobvious combinations and subcombinations of the various processes, systems, and configurations, and other features, functions, acts, and/or properties disclosed herein, as well as any and all equivalents thereof.

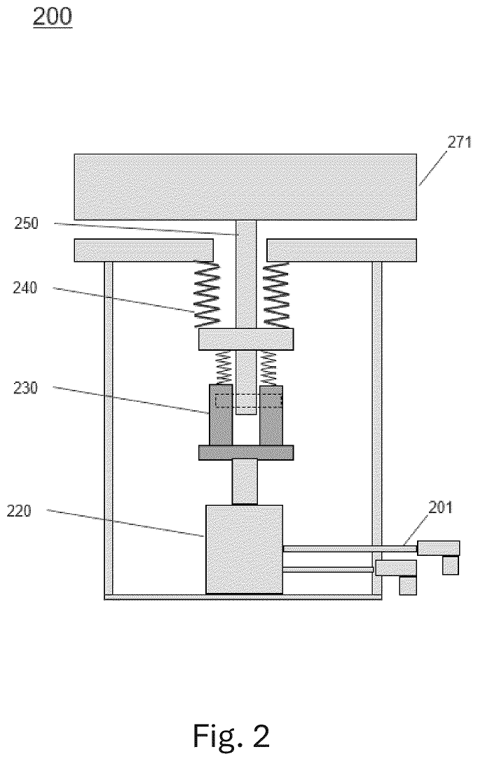

FIG. 2 illustrates an overview of a gate valve 200 according to an embodiment of the present disclosure.

The gate valve 200 may comprise an air cylinder 220, a cam unit 230, and a second shaft 250 with a bellows 240 around the second shaft 250. A seal plate 271 would include a passage to/from a chamber and how the passage would be open/close will be explained later.

The air cylinder 220 may be placed at the bottom and may be moved by injection of compressed dry air (CDA) supplied by air inlet 201. A cam unit 230 may be connected to the air cylinder 220.

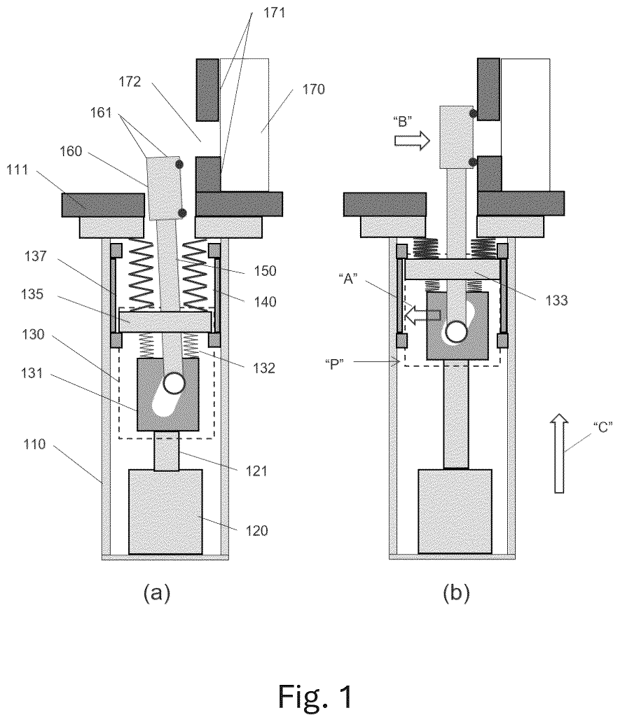

FIG. 1 (a) illustrates a sideview of a gate valve when it is open according to an embodiment of the present disclosure.

A housing 110 may contain the gate valve components described below and illustrated in FIG. 1(a). An air cylinder 120 may be connected to a cam unit 130 via a first shaft 121. The cam unit 130 may include a cam 131 and a second bellows 132. The cam 131 may be configured to change the direction of movement of the cam unit 130, i.e., from vertical to horizontal. The second bellows 132 may be configured to dampen shocks during the cam unit's movement and provide smoother operation. The cam unit 130 may also be configured to restrict vertical movement and define the uppermost position that the cam unit 130 can reach.

A second shaft 150 may be connected to the cam 131 and move vertically along with it. A slider 135 may be mounted around the second shaft 150. A bellows 140 may be disposed around the second shaft 150 and constrained by an upper housing 111. A guide rail 137 may be mounted on an inner wall of the housing 110 to guide the slider 135. The bellows 140 may be configured to prevent the cam unit 130 from colliding with the upper housing 111 and to return the cam unit 130 to its starting position.

A seal plate 160 may be attached to at the end of the second shaft 150 and how it may close a passage 172 to/from a chamber 170 may be illustrated in FIG. 1 (b). When CDA is injected into the air cylinder 120, the first shaft 121 would move the cam unit 130 upward to a topmost position P. Then the bellows 140 may be compressed as shown in FIG. 1 (b) due to its limit by upper housing 111 but the second shaft may go upward to a position where the seal plate can close the passage 172 in the seal plate 171. For air-tight closing of the passage 172, a seal ring 161 may be disposed around the seal plate 160 and configured to seal up the passage 172 when the seal plate 160 closes the passage 172.

The movement ‘A’ may happen when the cam unit 130 reaches its upmost position and the movement of cam unit 130 may be changed into a horizontal movement ‘A’ from a vertical one ‘C’. Due to this horizontal movement ‘A’, the movement ‘B’ may happen in the opposite direction of the movement ‘A’.

The speed and flow rate of the injected CDA may control the speed of the gate valve's open & close as stated above. That means large volume of CDA with high flow rate means fast movement of ‘C’ & ‘A’. Fast movement of ‘C’ may be good but fast movement of ‘B’ may mean particle problem caused by hard impact between the seal plate 160 and the seal plate 171.

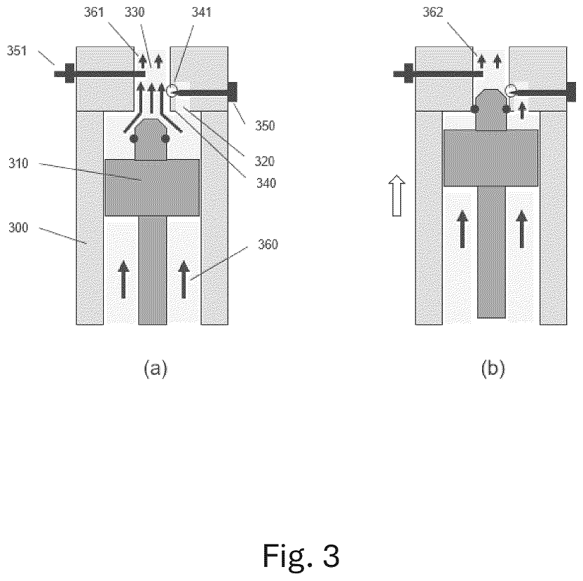

FIG. 3 (a) illustrates an inside view of the CDA unit when both air passages are open according to an embodiment of the present disclosure.

To control the injected CDA quantity (& flow rate), the CDA unit 280 may comprise a casing 300, a piston 310, a first air passage 320 and a second air passage 330, a separator 340 and a needle valve 350.

The piston 310 may be configured to move vertically by air flow 360 and a first air passage 320 and a second air passage 330 may be configured to control the amount of total air flow. The separator 340 may separate the first air passage 320 and the second air passage 330, and the separator 340 is equipped with a hole 341. The needle valve 350 may be disposed in the middle of the first air passage 320 and configured to control the flow of an air in the first air passage 320. When the piston 310 reaches at its upmost position, the piston 310 may block the second air passage 330 completely. Since the area of the second air passage 330 is much larger than that of the first air passage 320, the amount and flow rate of air going through the first air passage 320 may be reduced greatly. The amount of air 361 when the piston 310 doesn't block the second air passage 330 in FIG. 3 (a) is much larger than that of the air 362 when the piston 310 blocks the second air passage 330 in FIG. 3 (b).

FIG. 3 (b) illustrates an inside view of the CDA unit when second air passage 330 is blocked according to an embodiment of the present disclosure.

The rapid and voluminous air flow labeled as 361 may mean a fast movement of second shaft 150 upward vertically (‘C’) and the slow and small amount of air flow labeled as 362 may mean a slow horizontal movement (‘B’) and this is desirable because there may be fewer particles generated.

The second needle valve 351 disposed in the middle of the first passage and configured to control the flow of an air in the second passage 330. The first needle valve 3501 and the second needle valve 351 may be different in that the first needle valve 350 may control the air flow by blocking the hole 341 but the second needle valve 351 may control the air flow by blocking the second air passage 330 and without any hole.

The above-described arrangements of apparatus are merely illustrative of applications of the principles of this invention and many other embodiments and modifications may be made without departing from the spirit and scope of the invention as defined in the claims. The scope of the invention should, therefore, be determined not with reference to the above description, but instead should be determined with reference to the appended claims along with their full scope of equivalents.

1. A gate valve with speed control capability, the gate valve comprising:
a housing;
an air cylinder configured to move a first shaft vertically up to a first position, the first shaft being connected to the air cylinder;
a cam unit including a cam attached to the first shaft at one end;
a second shaft connected at an opposite end of the cam and configured to move along with the cam to a certain height;
a first bellows disposed around the second shaft;
a seal plate disposed at an end of the second shaft and configured to close a passage to/from a chamber;
a seal ring disposed around the seal plate and configured to seal up the passage when the seal plate closes the passage; and
a CDA unit configured to control an open/close speed of the gate valve,
wherein the CDA unit comprises:
a casing;
a piston configured to move vertically by air flow;
a first air passage and a second air passage for controlling an amount of air flow;
a separator configured to separate the first air passage and the second air passage, wherein the separator is equipped with a hole; and
a first needle valve disposed in a middle of the first air passage and configured to control a flow of an air in the first passage.

2. The gate valve according to the claim 1, the CDA unit further comprising:
a second needle valve disposed in a middle of the second air passage and configured to control a flow of an air in the second air passage.

3. The gate valve according to claim 1, wherein the piston configured to block the second air passage when the piston moves at highest point and the air only flows through the first air passage.

4. The gate valve according to claim 2, wherein the first needle valve and the second needle valve configured to independently control the air flow of the first air passage and the second air passage respectively.

5. The gate valve according to the claim 1, further comprises:
a second bellows configured to dampen shocks caused by movement of the cam;
a slider mounted around a second shaft; and
a guide rail mounted on an inner wall of the housing, the guide rail being configured to guide the slider and restrict vertical movement.

6. The gate valve according to the claim 1, wherein area of the second air passage is bigger than area of the first air passage.
